(19) United States
(12) Patent Application Publication
(10) Pub. No.: US 2012/0255945 A1
(43) Pub. Date: Oct. 11, 2012

(54) Induction Seal Coil and Method

(76) Inventors: Subir K. Dey, Florence, SC (US); Marion H. Weatherford, Hartsville, SC (US)

(21) Appl. No.: 13/079,837

(22) Filed: Apr. 5, 2011

(51) Int. Cl. B23K 13/01

(52) U.S. Cl. 219/603

(57) ABSTRACT

A method and apparatus are disclosed for sealing a metal end to an end of a non-metal body of a food container. The method includes placing the metal end onto the end of the non-metal body and inducing electrical currents in the peripheral portion only of the metal end to heat the peripheral portion. The peripheral portion is heated to a temperature and for a time sufficient to melt the non-metal end of the body. The inductive heating is then ceased to allow the molten material to re-solidify forming a bond and a seal with the metal end. The apparatus includes an annular copper coil sized and shaped to be positioned around or overlying the peripheral portion of the metal end. Passing radio frequency current through the copper coil induces heating currents in the peripheral portion of the end. Alignment features may be attached to the copper coil to align and center it with the metal end.

### TECHNICAL FIELD

This disclosure relates generally to containers for food and other items and more specifically to methods and devices for sealing a metal end to the plastic body of a food container, and specifically a can.

### BACKGROUND

Metal cans have long been used to contain a wide variety of food items. With increases in the price of metal, however, it is thought that multilayer extruded plastic tubes with metal ends may be price competitive with metal cans. A multilayer plastic body can be designed to be retortable and provides highly effective barrier against oxygen and thereby preserves freshness and flavor. Organoliptic properties of plastics also are good. Properly selected plastic material can be free of environmentally undesirable elements such as BPA, phthalates, and the like. It is therefore believed that food cans and other containers with plastic bodies to which metal ends are sealed offer promise. Sealing thicker and larger metal ends effectively and efficiently to a plastic can body, however, can present challenges.

Radio frequency heating devices, also known as inductive heating devices, have been used in the packaging industry to, for example, seal foil liners of bottle caps to the plastic material of the bottle opening. Early attempts to seal metal ends to plastic can bodies involved the use of such devices. These attempts generally have included seaming the ends of a plastic tube body to metal ends, followed by inductively heating the metal ends through radio frequency inductive heating to melt the plastic-metal interface in an attempt to obtain a bond. The metal of the end may be pre-coated with a plastic or other tie layer material having good bonding affinity for the plastic material of the body. Standard radio frequency induction sealing equipment normally used for sealing the foil liners of bottle caps has been used to attempt to melt the plastic-metal interface. Results have thus far not been completely satisfactory, particularly for use in modern high speed canning lines. Difficulties may be generally summarized as follows.

Normally the foil liners in a bottle cap are very thin, compared to the thickness of the metal in a metal can end. As is known in the induction heating industry, heating thicker metal requires a different range of radio frequency current in the induction head compared to the frequencies used to heat thin foil. For instance, inductively heating thin foils normally requires relatively higher frequencies of about 450 KHz and higher while heating the thicker metal of a can end requires relatively lower frequencies of about 150 KHz and lower. Existing induction sealing devices used in the food packaging industry to heat foils generally are not designed or easily adaptable to function at such lower frequencies.

Existing bottle cap induction coils are designed to heat the entire foil membrane of the caps thereby melting the interface between the foil and the plastic of the caps. During this heating, the foil liner is held securely in position by being captured between the bottle cap and the bottle to which it is attached. Since the mass of the metal liner in a bottle cap is very small, the total heat associated with this process also is small and little heat is imparted to the space between the cap and the contents of its bottle. However, when commercial induction heating equipment is used for sealing the much thicker and more massive metal end to a plastic can, the entire metal end is heated and, due to its mass, much more total heat energy is generated. While melting of the plastic-metal interface is obtained, other challenges are created. For example, the heated metal end increases, through radiant heating, the temperature in the head space between a food item in the can and the metal end. This, in turn, results in higher internal pressure within the can. Since the bonding strength between at the plastic-metal interface is low when the plastic is molten, the internal pressure tends to cause the metal end to pop off of the plastic body unless the end is held against the body until the plastic re-solidifies. Providing a hold-down mechanism in a modern packaging machine is disadvantageous at least because it increases the cost and complexity of the packaging machine and, since it can take the molten plastic some time to solidify, can slow down the packaging process.

A need exists for a device and method for sealing a metal end to an extruded plastic body in a food packaging process that successfully addresses the above and other shortcomings. It is to the provision of such a device in the form of an improved induction seal coil and a method of sealing metal ends to plastic can bodies using such a coil that the present invention is primarily directed.

### SUMMARY

Briefly described, and in one embodiment, an induction or radio frequency induction heating coil comprises hollow rectangular copper conductor formed into an annular loop. The annular loop is sized to be fitted around or adjacent the rim only of a metal end that has been mechanically seamed to an end of a plastic can body. Passage of electrical current through the copper conductor at the appropriate resonate frequency induces heating currents in the metal end and these currents are concentrated in the rim portion of the metal end. The rim of the metal end is thus heated to cause the plastic of the can body to melt and fuse with metal end to form a bond and a seal. The coil is designed such that little or no heating occurs in the central portion of the metal end, which stays generally cool. Since the entire metal end is not heated, very little heat is generated in the head space between the metal end and the food inside the can, and so very little excess pressure is imparted to the can. As a result, the end does not tend to pop off during the time when the plastic is molten and before it re-solidifies. Further, since the central portion of the metal end remains cool, it acts as a heat sink after application of the inductive heating and draws heat from the rim portion of the metal end. This, in turn, results in rapid cooling of the rim portion, which causes the melted plastic of the can body to solidify quickly forming a strong bond and air-tight seal with the metal end. Accordingly, the step of sealing the end to the can occurs relatively quickly and does not slow down a packaging machine in which the invention is deployed.

Thus, an improved inductive heating coil is provided that is effective, efficient, and particularly suitable for sealing relatively massive metal ends to plastic can bodies. These and other features, aspects, and advantages will become more apparent upon review of the detailed description set forth below when taken in conjunction with the accompanying drawing figures, which are briefly described as follows.

### BRIEF DESCRIPTION OF THE DRAWINGS

FIG. 1 is a perspective view of an induction seal coil that embodies aspects of the invention in one preferred embodiment.

FIG. 2 is a perspective view showing the induction seal coil of FIG. 1 positioned around the rim of a metal end mechanically seamed to an end of a plastic can body.

FIG. 3 is a top plan view of the annular copper coil according to aspects of the invention.

FIG. 4 is a cross sectional view taken along line A-A of FIG. 3 illustrating the hollow interior of the annular copper coil through which cooling water can be pumped.

FIG. 5 is a cross sectional view showing the induction sealing coil positioned around the rim of a metal end mechanically seamed to an end of a plastic can body.

FIG. 6 is a cross sectional view illustrating an alternate embodiment of the invention wherein the annular coil is positioned just above rather than around the rim of the metal end.

### DETAILED DESCRIPTION

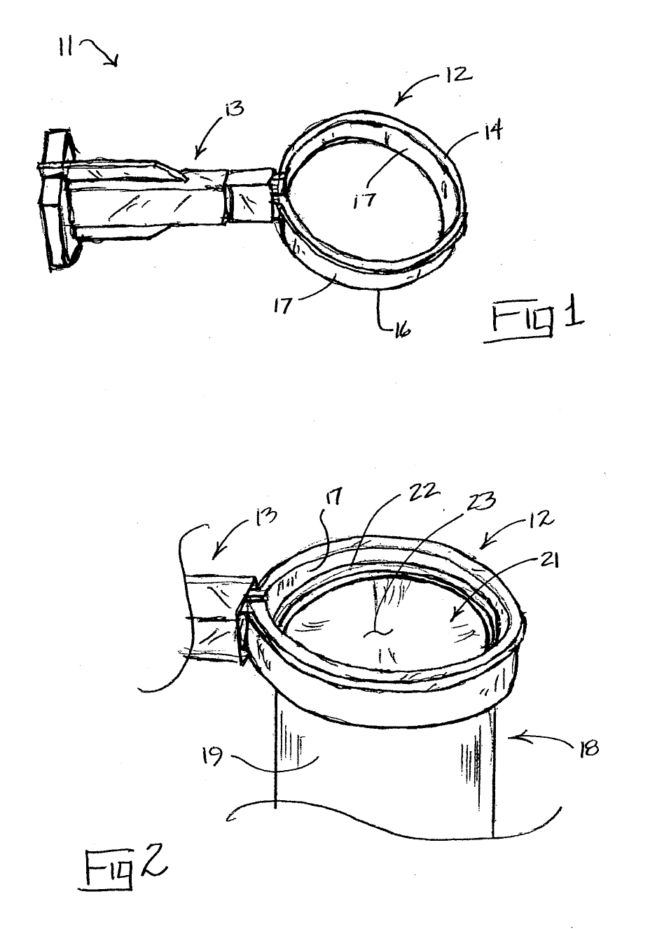

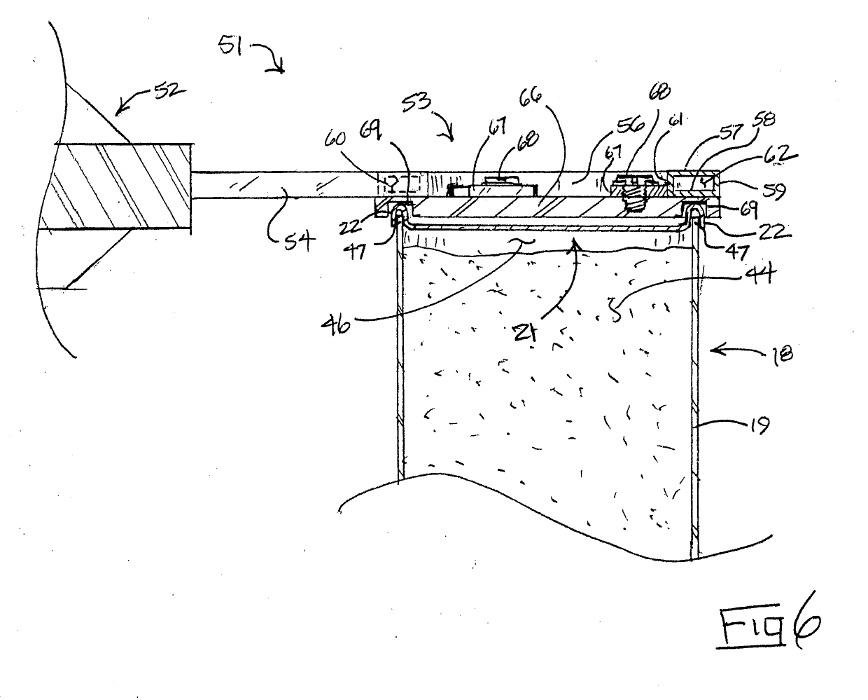

Reference will now be made to the drawing figures, wherein like reference numerals designate like parts throughout the various views. FIG. 1 illustrates an induction seal coil assembly 11 embodying aspects of the invention. The assembly 11 comprises an annular coil portion 12 attached to a fixture 13 designed to couple the coil portion to a source of radio frequency current and a cooling fluid such as water. The coil portion 12 contains a copper conductor that may be surrounded by an dielectric or non-conducting jacket 38 (FIG. 4). FIG. 2 shows the induction seal coil assembly positioned over the top of a can 18 for sealing a metal end 21 to the top edge of a plastic can body 19. In this illustration, the metal end is disc-shaped and the plastic body is generally cylindrical; however, this should not be construed to be a limitation of the invention and any container configuration may be accommodated. In any event, the coil portion 12 in this embodiment is positioned to surround the rim 22 of the metal end, as perhaps better illustrated in FIG. 5. The lip 41 (FIG. 4), if present, may assist in the proper positioning of the coil portion 12 on the top of the can such that the distance between the copper conductor and the rim of the can remains constant around the rim.

With the coil portion so positioned, high frequency electric current is passed through the copper conductor 27. The frequency of the current is set approximately to the resonate frequency of the system determined by the capacitance of the electronic supply and the inductance of the copper conductor of the coil. It has been found that, for a typical size metal end, an electrical current of about 100 amps with a frequency of about 16 KHz functions well with the test equipment used by the inventors. However, it will be understood that these parameters will vary and can vary significantly depending upon application specific conditions including the capacitance and reactance of the system. The relationship between frequency (f), reactance (L) and capacitance (C) of a particular radio frequency system is defined by the equation:

2πf=1/(LC)^{1/2}

Thus, although 16 KHz functioned well during inventor investigations, frequencies between about 10 KHz and about 450 KHz may be appropriate depending upon the characteristics of the system being used. In any event, the current passing through the conductor causes, through electrical induction, corresponding electrical currents to develop within the rim 22 of the metal end. These currents, in turn, cause the rim to heat resistively and rapidly to a temperature sufficient to melt the plastic of the can body, which previously has been mechanically seamed to the metal end. The molten plastic bonds to the metal of the rim. A tie layer coating with an affinity for the molten plastic may be applied to the metal end to improve the bond. When the molten plastic cools, it re-solidifies to form a very secure bonded attachment with the metal end and a substantially complete seal between the metal end and the plastic can body.

It has been discovered that the above method and apparatus provides several unique and somewhat surprising advantages in this application over traditional induction heating systems. For instance, since virtually all of the induced currents in the metal end are localized to the rim, the rim of the metal end heats very rapidly to the temperature required to melt the plastic of the adjoined body. Thus, dwell time is low and production rate can be high. Further, after treatment, the central portion 23 of the metal end remains relatively cool and serves as a heat sink to draw and dissipate heat from the rim of the metal end. This causes the molten plastic to re-solidify substantially more rapidly than it otherwise would have, had the entire end been heated as is the case in the prior art. Again, dwell time remains low and production rate remains high. In addition, and perhaps most salient, due to the rapid localized heating and cooling of the rims of the metal end, and the fact that the central portion of the end is not heated in the process, the headspace between the contents of the can and the metal end remain cool and pressure within the can does not rise significantly. The result is that metal ends do not pop off of their plastic can bodies while the plastic is in a molten state. Accordingly, no ancillary hold-down mechanism needs to be added to a packaging machine in which the coil is implemented.

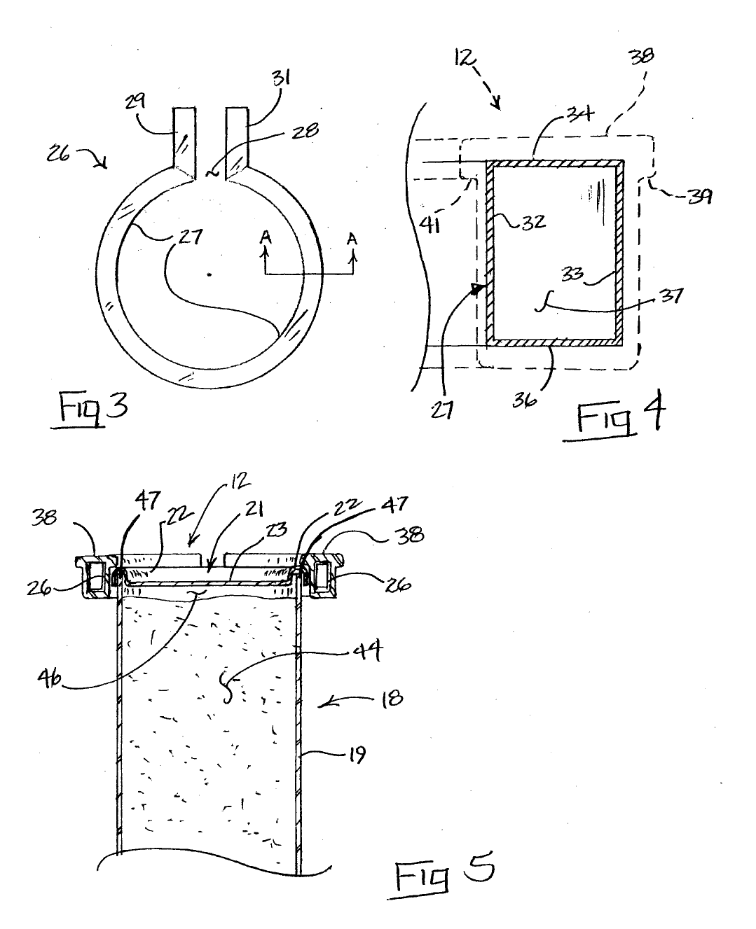

Embodiments of the invention will now be described in more detail with reference to FIGS. 3-6. FIGS. 3 and 4 illustrate one embodiment of the coil portion of FIG. 1. The coil portion 12 in this embodiment comprises a copper conductor 26 shaped to form an annular section 27 that is discontinuous at gap 28. Connectors 29 and 31 project from the annular section 27 at the gap 28 such that an electrical circuit is formed by the copper conductor between the connector 29 and the connector 31. The connectors 29 and 31 are configured for connection to a supply of radio frequency current and a supply of cooling water. As shown in FIG. 4, the copper conductor 26 in this embodiment is generally rectangular in cross section having an inside wall 32, and outside wall 33, a top wall 34, and a bottom wall 36. The walls bound and define a hollow interior channel 37 through which cooling water or other fluid can be circulated to cool the copper conductor, which otherwise may overheat and possibly melt as a result of the electrical current flowing through the conductor. The conductor 27 may be sheathed in a non-conducting jacket 38 (shown in phantom lines) to insulate the conductor from the metal end of a can and other structures. The jacket 38 can be formed, if desired, with one or more lips 39 and 41 to aid in positioning the coil properly around the rim of a metal end. The lips need not be provided, however, and the coil may be positioned by associated machinery, jigs, or other structures.

FIG. 5 illustrates in cross section the coil portion 12 positioned around the rim 22 of a metal end 23 that has been seamed to the top edge 47 of a plastic can body 18. The metal end 21 is configured with a central portion 23 surrounded by a rim 22. The rim 22 has an upstanding portion that forms a channel 24 within which the edge 47 of the plastic can body 19 is seated and mechanically seamed as is known in the art. The can has been filled with contents 44, which can be any food item traditionally stored in a metal can. A small head space 46 is defined between the contents 44 and the metal end 21. The coil portion 12 is shown positioned atop the can 18 surrounding the rim 22 of the metal end 21. The copper conductor 26 resides adjacent the rim 22 and is equally spaced from the rim around its extent. It has been found that spacing the coil equally around the rim of the metal end; i.e., centering the coil with respect to the metal end, prevents the metal end from becoming distorted and/or buckling due to internal stresses created by uneven heating of the rim. When radio frequency current is applied to the copper conductor of the coil portion 12, the rim and channel of the metal end are heated and the plastic around the top edge of the can body 19 melts within the channel. This bonds the metal end to the can and creates a seal. Further, as discussed above, rapid cooling is achieved by the heat sink created by the central portion of the metal end and pressure does not tend to build up in the can due to heating of the head space 46.

In order to improve the bond between the plastic of the can body and the metal end, a coating or tie layer preferably is applied at least within the channel of the rim 22, and may be applied to the entire inner surface of the end. For example, if the material of the plastic body 19 is a polypropylene, then a polypropylene coating can be applied to the inside surface of the metal end and/or within the channel. This tie layer material has an affinity for the molten plastic of the can body and enhances the bond and seal created between the plastic of the can body and the metal of the end.

FIG. 6 illustrates an alternate embodiment of the induction seal coil that perhaps better addresses the need to center the induction coil around the rim of the metal end. In this embodiment, an induction coil assembly 51 comprises a fixture 52 from which a coil portion 53 extends. The coil portion 53 includes an annular copper conductor 56 discontinuous at gap 60 that is connected to the fixture 52 by connectors 54 (only one of which is visible here) to define an electrical circuit through the annular copper conductor 56. In this embodiment, the annular conductor 56 is sized to overlie the rim 22 of a metal end 21 rather than surrounding the rim as in the previous embodiment. A disc-shaped plate made of dielectric or non-conducting material is mounted to the bottom of the annular conductor 56 and can be secured with screws extending through screw tabs 67 and threaded into the plate 66. Any other means of securing the dielectric disc to the annular conductor also may be implemented.

The non-conducting dielectric disc 66 is formed on its bottom surface with an annular groove or race 69 that is sized to receive the rim 22 of the metal end when the coil is positioned atop the can. The annular groove is positioned below the annular conductor 57 such that when the rim 22 of the end is nestled within the annular groove 69, the metal conductor 57 is precisely centered and aligned just above the rim. It has been found that this embodiment effectively addresses the need to center the coil with respect to the rim and thereby to prevent distortion and buckling of the metal end due to uneven heating of the rim. As with the previous embodiment, application of a radio frequency current to the annular copper conductor induces currents in the rim of the metal end that heats the rim to melt the plastic edge of the can body within the channel of the rim thereby creating a bond and a seal. Again, the heat imparted to the rim is rapidly dissipated into the cool central portion of the metal end and pressure buildup within the can is minimized because the head space 21 within the can is not significantly heated in the process.

### EXAMPLES

### Embodiment 1

The induction seal coil of the first embodiment described above was constructed and tested. In this embodiment and this example test, an attempt was made to heat only the very outside rim of the metal end. The configuration of the induction seal coil relative to the metal end for this test is illustrated in FIG. 5. All the tests were done with “Minac 18 Twin” induction heating system manufactured by EFD Induction A.S. The use of power supplies and electronics from other suppliers will also work. All experiments were done with polypropylene plastic can bodies and metal ends, one side of which was coated with a polypropylene tie layer and the other side of which was coated with polyester. Good bonding between the metal end and the plastic wall without significant pressure being developed within the can was achieved at a current of about 100 amps and a frequency of about 16 KHz applied for a duration of about 0.1 seconds. Due to the limitation of the electronics, smaller time duration could not be tested, but it is believed that smaller durations also may be successful. For currents significantly higher than about 100 amps, the outer polyester coating of the metal end began to melt, which is an unacceptable result. For significantly smaller currents, longer duration was necessary to achieve good bonding between the plastic can body and the metal end. It was surmised from the test that, for the tested 16 KHz frequency, acceptable current applied to the induction seal coil ranged between about 50 amps and about 150 amps, or more precisely between about 75 amps and about 125 amps, and even more precisely about 100 amps. One of the issues faced with this coil design is the centering of the coil around the rim. If proper centering was not achieved, the metal end was found to buckle due to internal stress relaxation caused by uneven heating.

### Embodiment 2

In the second coil design, the conductor coil was placed above the rim as shown in the FIG. 6. To achieve better centering, a dielectric plate with annular groove was attached to the coil as shown. The groove was designed so that the metal rim of the metal end nestled in the groove centered beneath the copper conductor. The same electronic power supply and hardware from EFD was used for the test. The result with this coil was found to be very similar to results with the previous coil with the acceptable current and duration values being substantially the same. However, due to better centering between the copper conductor of the coil and the rim of the metal end, the metal end did not buckle. In addition, it was found that immediately after the radio frequency application, the coil could be removed by lifting it straight up without any detrimental result. This was thought to be due to the fact that the rim was very quickly heated to melt the polymer of the can body and, due to high thermal conductivity of the metal end, heat is dissipated from the rim very quickly. This is achieved without heating up the head space air and thereby increasing pressure within the can.

The invention has been described herein in terms of preferred embodiments and methodologies considered by the inventors to represent the best mode of carrying out the invention. It will be clear to those of skill in the art, however, that a wide variety of additions, deletions, and modifications might well be made to the illustrated embodiments. For example, while copper is the preferred material for the conductor of the coil, other metals or conductive materials might be substituted to obtain similar results. Further, the conductor itself need not be rectangular in cross section as illustrated. Instead it might be formed with other profiles designed for a specific sealing scenario. Also, when sealing a metal end to a non-cylindrical can body, the coil would not be shaped in an annular configuration as in the illustrated embodiments, but instead would be shaped to conform to the peripheral profile of the corresponding non-circular metal end. These and other variations, both subtle and gross, may be made to the illustrated embodiments without departing from the spirit and scope of the invention, which is limited only by the claims.

1. An induction seal coil assembly for sealing a metal end having a peripheral portion and a central portion to a non-metal body of a container, the induction seal coil assembly comprising:
a source of electrical current having a selected frequency;
an electrical conductor shaped to extend substantially along the extent of and adjacent to the peripheral portion of the metal end while not extending adjacent to the central portion of the metal end, the conductor being part of an electrical circuit; and
a fixture for electrically coupling the conductor to the source of electrical current to establish current flow through the conductor at a selected amperage level and frequency.

2. An induction seal coil assembly as claimed in claim 1 and wherein the electrical conductor is shaped and sized to extend around and outboard of the peripheral portion of the metal end.

3. An induction seal coil assembly as claimed in claim 2 and wherein the electrical conductor defines an internal channel.

4. An induction seal coil assembly as claimed in claim 3 and wherein the electrical conductor is substantially rectangular in cross section and bounds and defines a substantially rectangular internal channel.

5. An induction seal coil assembly as claimed in claim 1 and wherein the electrical conductor is shaped and sized to extend above the peripheral portion of the metal end.

6. An induction seal coil assembly as claimed in claim 5 and wherein the electrical conductor defines an internal channel.

7. An induction seal coil assembly as claimed in claim 6 and wherein the electrical conductor is substantially rectangular in cross section and bounds and defines a substantially rectangular internal channel.

8. An induction seal coil as claimed in claim 1 and wherein the metal end is substantially disc-shaped and the electrical conductor is shaped to be substantially annular.

9. An induction seal coil as claimed in claim 8 and wherein the electrical conductor is sized to extend around and outboard of the peripheral portion of the metal end.

10. An induction seal coil as claimed in claim 8 and wherein the electrical conductor is sized to extend above the peripheral portion of the metal end.

11. An induction seal coil as claimed in claim 10 and further comprising a centering plate attached to the electrical conductor for positioning atop the metal end, the centering plate being formed with a feature that interacts with the peripheral portion of the metal end to align the electrical conductor with the peripheral portion of the metal end.

12. An induction seal coil as claimed in claim 11 and wherein the peripheral portion of the metal end includes an upstanding rim and wherein the centering plate is formed with an annular groove that receives the upstanding rim to align the electrical conductor with the rim.

13. An induction seal coil as claimed in claim 1 and further comprising a non-conducting material substantially incasing the electrical conductor.

14. An induction seal coil assembly for sealing a generally disc-shaped metal end having a central portion and a peripheral portion with a rim configured to receive an end of a generally cylindrical plastic body, the induction seal coil assembly comprising:
a generally annular electrical conductor having an internal channel and being sized to extend substantially along the extent of and adjacent to the rim of the metal end, the electrical conductor being discontinuous at a gap to form an electrical circuit;
connectors for coupling the electrical conductor to a source of radio frequency electrical current; and
an alignment feature on the electrical conductor for aligning the conductor with the rim of a metal end when the electrical conductor is brought in proximity with the metal end.

15. The induction seal coil assembly of claim 14 and wherein the electrical conductor is sized to extend around and outboard of the rim and wherein the alignment feature includes a rim on the electrical conductor sized to rest atop the rim.

16. The induction seal coil assembly of claim 14 and wherein the electrical conductor is sized to extend above the rim and wherein the alignment feature comprises a disc on the electrical connector having an annular groove sized to receive the rim of the metal end.

17. A method of sealing a metal end having a peripheral portion and a central portion to a non-metal body of a container comprising the steps of:
(a) positioning the metal end on the non-metal body with peripheral portion of the metal end engaging an end of the non-metal body;
(b) inducing alternating electrical currents in the peripheral portion of the metal end sufficient to heat the peripheral portion while not heating the central portion of the end;
(c) maintaining the induced electrical currents for a time sufficient to melt the end of the non-metal body in engagement with the peripheral portion of the metal end; and
(d) ceasing inducement of electrical currents in the peripheral portion of the metal end and allowing the melted portion of the non-metal body to solidify to form a bond and a seal with the metal end.

18. The method of claim 17 and wherein the peripheral portion of the metal end comprises a rim defining a channel and wherein step (a) comprises positioning the end of the non-metal body in the channel.

19. The method of claim 17 and wherein step (b) comprises positioning an induction coil adjacent the peripheral portion of the metal end and generating a selected electrical current at a selected frequency in the induction coil.

20. The method of claim 19 and wherein the selected current is between about 50 amps and about 150 amps.

21. The method of claim 20 and wherein the selected current is between about 75 amps and about 125 amps.

22. The method of claim 21 and wherein the selected current is about 100 amps.

23. The method of claim 19 and wherein the selected frequency is between about 16 KHz and about 450 KHz.

24. The method of claim 19 and wherein the positioning step comprises locating the coil around and outboard of the peripheral portion of the metal end.

25. The method of claim 19 and wherein the positioning step comprises locating the coil above the peripheral portion of the metal end.
